(19) United States
(12) Patent Application Publication
(10) Pub. No.: US 2025/0198467 A1
(43) Pub. Date: Jun. 19, 2025

(54) ARRANGEMENT COMPRISING PLANETARY STAGES AND A SPLINE

(71) Applicants: ZF FRIEDRICHSHAFEN AG, Friedrichshafen (DE); ZF Wind Power Antwerpen N.V., Lommel (BE)

(72) Inventors: Warren SMOOK, Huldenberg (BE); Sven MOERS, Westerlo (BE)

(21) Appl. No.: 18/832,993

(22) PCT Filed: Jan. 4, 2023
(86) PCT No.: PCT/EP2023/050112

§ 371 Date: Jul. 25, 2024

(30) Foreign Application Priority Data
Jan. 27, 2022 (DE) 10 2022 200 896.0

(51) Int. Cl. F16D 3/06; F16H 1/46

(52) U.S. Cl. CPC F16D 3/06; F16H 1/46

(57) ABSTRACT

An arrangement including a first planetary stage and a second planetary stage. A sun shaft of the first planetary stage is connected to a planet carrier of the second planetary stage for conjoint rotation by a spline joint. A web of the planet carrier is arranged axially between planet gears of the first planetary stage and planet gears of the second planetary stage. The spline joint is axially spaced apart from the web.

### CROSS REFERENCE TO RELATED APPLICATIONS

This application is a U.S. National Phase application under 35 U.S.C. § 371 of International Application No. PCT/EP2023/050112, filed on Jan. 4, 2023, and claims benefit to German Patent Application No. DE 10 2022 200 896.0, filed on Jan. 27, 2022. The International Application was published in German on Aug. 3, 2023 as WO 2023/143883 A1 under PCT Article 21 (2).

### FIELD

The invention relates to a planetary gear arrangement.

### BACKGROUND

Wind turbine transmissions having a first planetary stage and a second planetary stage are known from the prior art. A sun gear of the first planetary stage is connected to a planet carrier of the second planetary stage for conjoint rotation by means of a sun shaft. The sun shaft forms a spline joint together with the planet carrier. The spline joint is located inside the planet carrier and is surrounded by a wall of the planet carrier.

The sun shaft is connected to the sun gear for conjoint rotation. Since the toothing of the sun gear is exposed to particular stresses, the sun gear and thus also the sun shaft have to be made of a high-strength material. This increases the production costs of the transmission. At the same time, the stability under load is restricted since the diameter of the sun shaft is limited by the planet carrier.

### SUMMARY

In an embodiment, the present disclosure provides an arrangement comprising a first planetary stage and a second planetary stage. A sun shaft of the first planetary stage is connected to a planet carrier of the second planetary stage for conjoint rotation by a spline joint. A web of the planet carrier is arranged axially between planet gears of the first planetary stage and planet gears of the second planetary stage. The spline joint is axially spaced apart from the web.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a wind turbine transmission;

FIG. 2 shows a first detail of the wind turbine transmission;

FIG. 3 shows a second detail of the wind turbine transmission; and

FIG. 4 shows a third detail of the wind turbine transmission.

### DETAILED DESCRIPTION

In an embodiment, the present invention provides a transmission having improved properties by comparison with the prior art.

The arrangement according to an embodiment of the invention comprises a first planetary stage and a second planetary stage. A planetary stage refers to a transmission or a sub-transmission having a ring gear, one or more planet gears, a planet carrier, and a sun gear. The planet gears are rotatably mounted in the planet carrier and each mesh with the ring gear and/or the sun gear. Exactly two of the three components out of the ring gear, planet carrier, and sun gear are rotatably mounted; the third component is arranged non-rotatably with respect to a transmission casing. For example, the planet carrier and the sun gear can be rotatably mounted, whereas the ring gear is non-rotatably connected to the transmission casing.

The arrangement is preferably part of a wind turbine transmission.

The first planetary stage and the second planetary stage are coupled to one another by means of a sun shaft. A sun shaft refers to a shaft that is connected to a sun gear for conjoint rotation. In the present case, the sun shaft is connected to the sun gear of the first planetary stage for conjoint rotation. In particular, the sun shaft can be integrally connected to the sun gear. Said sun shaft is connected to a planet carrier of the second planetary stage for conjoint rotation by means of a spline joint.

A spline joint refers to an arrangement comprising a first toothing and a second toothing. The first toothing and the second toothing are arranged coaxially with one another; in other words, they have a common central axis and intermesh such as to produce a connection for conjoint rotation. The first toothing is configured as an external toothing, the second toothing as an internal toothing.

The planet carrier of the second planetary stage has at least one web. This web is a planet carrier portion which extends at least partly radially, i.e., orthogonally to an axis of rotation of the two rotatably mounted components of the second planetary stage, and in which one or more planet bolts are secured.

A planet bolt refers to a pin on which a planet gear is mounted. The web forms one or more bolt seats for securing the planet bolts.

In the present case, the web is arranged axially between the planet gears of the first planetary stage and the planet gears of the second planetary stage. The axial course of the web is thus also limited by the planet gears of the first planetary stage in addition to the planet gears of the second planetary stage. Therefore, the planet gears of the first planetary stage and the web are located on different sides of a radially extending first plane. The planet gears of the second planetary stage and the web are located on different sides of a radially extending second plane. The web extends between the first plane and the second plane.

According to an embodiment of the invention, the spline joint is axially spaced apart from the web. There is thus an offset between the spline joint and the web in the axial direction. The web therefore extends axially between the spline joint and the planet gears of the second planetary stage. The spline joint and the web are located on different sides of the second plane. Since the spline joint is connected to the sun gear by means of the sun shaft, the spline joint is furthermore located axially between the sun gear and the web. It is thus located between the second plane and a third plane, which likewise extends radially and extends between the sun gear and the spline joint such that the sun gear and the spline joint are located on different sides of the third plane.

As a result of embodiments of the invention, the sun shaft is shortened. Material that can thus be saved in the sun shaft is added to the planet carrier. This is advantageous since the material of the planet carrier is subject to lower demands in terms of stability under load. Embodiments of the invention thus make it possible to save on heavy-duty and thus expensive material on the sun shaft, replacing it with cheaper material on the planet carrier.

Moreover, the axial offset between the spline joint and the web of the planet carrier means that the restrictions on the dimensions of the spline joint in the axial direction can be removed. As a result, the spline joint can be dimensioned to be larger in the axial direction such that the spline joint can transmit higher torques.

In a preferred development, a hollow shaft which is integrally connected to the web is provided. The hollow shaft has the internal toothing of the spline joint. The external toothing thereof is formed by the sun shaft. The axial offset of the spline joint in accordance with embodiments of the invention can be implemented in a simple manner by the hollow shaft according to the development.

Preferably, the hollow shaft is developed further by a shoulder. This shoulder preferably extends in the interior of the hollow shaft. A shoulder refers to an annular, radially oriented surface.

According to the development, the shoulder abuts the sun shaft. In this way, the shoulder limits the ability of the sun shaft to shift in an axial direction. Preferably, the shoulder is screwed to the sun shaft. As a result, the sun shaft is fully secured in the shoulder.

In a preferred development, besides the spline joint, the shoulder is also axially spaced apart from the web. The web and the shoulder thus extend on different sides of the first plane. In addition, there is an axial offset between the web and the shoulder. Preferably, this offset is bridged by the aforementioned hollow shaft.

In a preferred development, the web forms the shoulder. In this case, there is no axial offset between the web and the shoulder. Instead, the shoulder is at least partly encompassed by the web.

The hollow shaft is preferably developed further by a protrusion. This protrusion extends axially from the spline joint, in particular from the external toothing thereof, toward the sun gear. The protrusion is a part of the hollow shaft that elongates the hollow shaft from the spline joint toward the sun gear. The protrusion and the spline joint are located on different sides of a radially oriented fourth plane. The sun gear is located on the same side of the fourth plane as the protrusion. The spline joint is arranged between the fourth plane and the second plane.

The protrusion increases the stability under load of the spline joint. If an axially directed torque is exerted on the spline joint, radial forces that dilate the hollow shaft outward are produced in the spline joint. The dilation of the hollow shaft increases from the second planetary stage toward the first planetary stage. The protrusion counteracts this dilation. The arrangement of the protrusion in accordance with the development thus results in dilation that is largely uniform over the axial course of the spline joint.

Preferred embodiment examples are shown in the drawings. In these, matching reference numerals denote identical or functionally identical features.

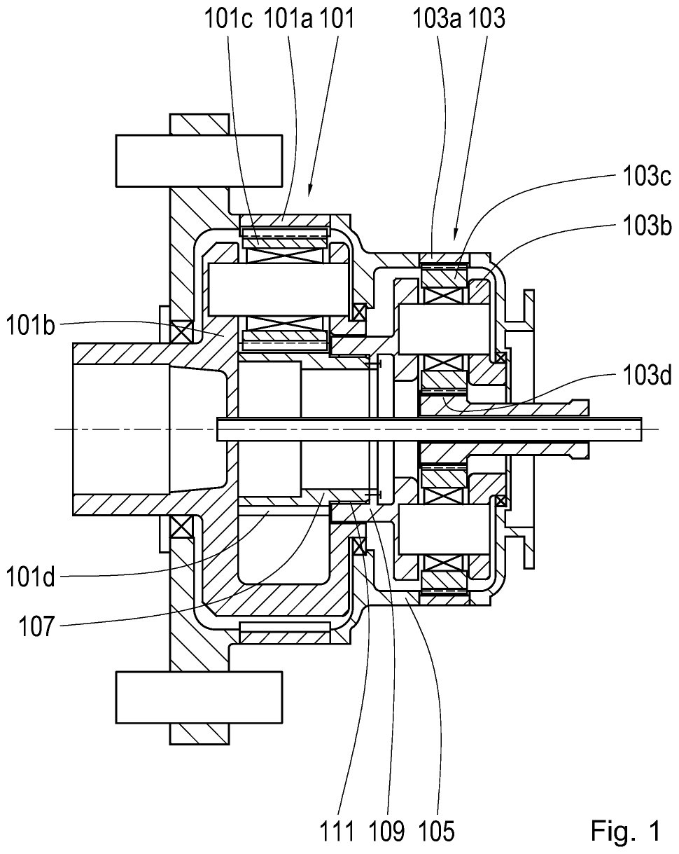

The wind turbine transmission shown in FIG. 1 comprises a first planetary stage 101 and a second planetary stage 103. The planetary stages 101, 103 each have a ring gear 101a, 103a, a rotatably mounted planet carrier 101b, 103b, planet gears 101c, 103c that are rotatably mounted in the respective planet carriers 101b, 103b, and a rotatably mounted sun gear 101d, 103d. The planet gears 101c, 103c of each planetary stage 101, 103 mesh with the relevant ring gear 101a, 103a and the relevant sun gear 101d, 103d. The ring gears 101a, 103a form a part of a casing 105 of the wind turbine transmission and are accordingly integrated in the casing 105 in a non-rotatable manner.

The sun gear 101d of the first planetary stage 101 is integrally connected to a sun shaft 107. This sun shaft forms a spline joint 111 together with a hollow shaft 109. The hollow shaft 109 is part of the planet carrier 103b of the second planetary stage 103 and is integrally connected thereto. The sun shaft 107 and the hollow shaft 109 are interconnected for conjoint rotation by means of the spline joint 111.

Starting from a rotor-side web of the planet carrier 103b of the second planetary stage 103, the spline joint 111 is arranged to be offset on the rotor side to such an extent that the planet carrier 101b of the first planetary stage 101 surrounds the spline joint 111. This results in a short sun shaft 107. A gap from the spline joint 111 to the planet carrier 103b of the second planetary stage 103 is bridged by the hollow shaft 109.

By arranging the spline joint 111 to be offset on the rotor side, the spline joint 111 is not stabilized outward by the planet carrier 103b of the second planetary stage 103.

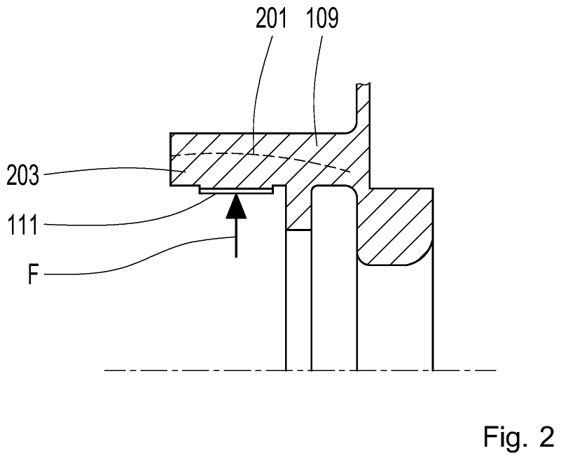

The transmission of a driving torque leads to the spline joint 111 widening outward owing to a resulting radial force F. A corresponding bending line 201 is indicated in FIG. 2.

If the hollow shaft 109 were to end on the rotor side with the spline joint 111, the spline joint 111 would widen further on the rotor side than on the generator side. Therefore, to achieve a more uniform bending line 201, the hollow shaft 109 is elongated beyond the spline joint 111 on the rotor side. A protrusion 203 arranged accordingly on the rotor side in relation to the spline joint 111 counteracts widening of the spline joint 111.

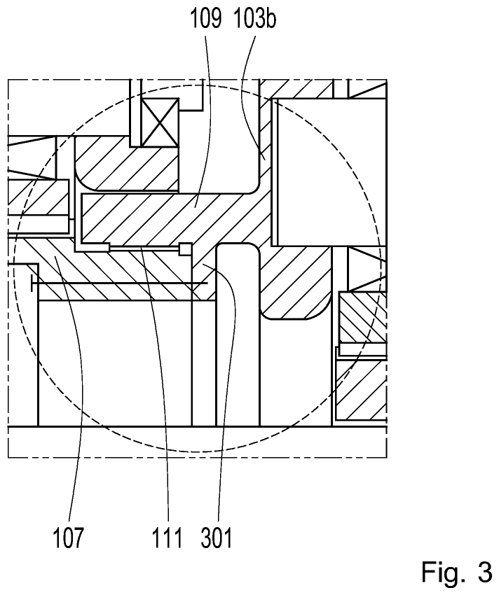

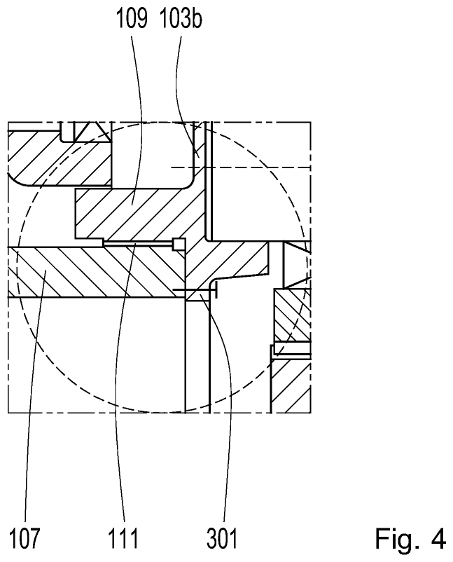

To secure the sun shaft 107, the hollow shaft 109 has a shoulder 301, which is shown in FIGS. 3 and 4. The sun shaft 107 abuts the shoulder 301 by an end face and is screwed to said shoulder.

According to FIG. 3, the shoulder 301 is axially spaced apart from the planet carrier 103b of the second planetary stage 103. Alternatively, the planet carrier 103b of the second planetary stage 103 can form the shoulder 301, as shown in FIG. 4.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE NUMERALS

101 First planetary stage
101a Ring gear
101b Planet carrier
101c Planet gear
101d Sun gear
103 Second planetary stage
103a Ring gear
103b Planet carrier
103c Planet gear
103d Sun gear
105 Casing
107 Sun shaft
109 Hollow shaft
111 Spline joint
201 Bending line
203 Protrusion
301 Shoulder

1. An arrangement comprising:
a first planetary stage; and
a second planetary stage,
wherein a sun shaft of the first planetary stage is connected to a planet carrier of the second planetary stage for conjoint rotation by a spline joint,
wherein a web of the planet carrier is arranged axially between planet gears of the first planetary stage and planet gears of the second planetary stage, and
wherein the spline joint is axially spaced apart from the web.

2. The arrangement according to claim 1, further comprising a hollow shaft integrally connected to the web,
wherein the hollow shaft has an internal toothing,
wherein the sun shaft has an external toothing, and
wherein the internal toothing and external toothing intermesh for conjoint rotation.

3. The arrangement according to claim 2, wherein the hollow shaft forms a shoulder that the sun shaft abuts.

4. The arrangement according to claim 3, wherein the shoulder is axially spaced apart from the web.

5. The arrangement according to claim 3, wherein the web forms the shoulder.

6. The arrangement according to claim 2, wherein the hollow shaft has a protrusion that extends axially from the spline joint toward a sun gear of the first planetary stage.
